(19) United States
(12) Patent Application Publication
(10) Pub. No.: US 2015/0158761 A1
(43) Pub. Date: Jun. 11, 2015

(54) GLASS SHEET AND METHOD FOR MANUFACTURING SAME

(71) Applicant: HON HAI PRECISION INDUSTRY CO., LTD., New Taipei (TW)

(72) Inventors: CHIU-CHI CHEN, Zhubei (TW); TEN-HSING JAW, Zhubei (TW); SZU-WEI SUNG, New Taipei (TW); CHIN-YANG WU, Zhubei (TW)

(21) Appl. No.: 14/564,282

(22) Filed: Dec. 9, 2014

(30) Foreign Application Priority Data
Dec. 10, 2013 (TW) 102145288

(51) Int. Cl. C03C 17/34; B05D 3/06; B05D 3/12; C03C 17/00

(52) U.S. Cl. CPC C03C 17/3411; C03C 17/002; B05D 3/067; B05D 3/12; C03C 2217/77; C03C 2218/156

(57) ABSTRACT

A glass sheet includes a base plate, a first coating layer, a second coating layer, and a shielding layer. The base plate includes a display area, and a non-display area surrounding the display area. The first coating layer is formed on the non-display area of the base plate, includes a first bright colored ink, and defines a number of wiredrawing finishing textures separated from each other. The second coating layer is filled in the number of wiredrawing finishing textures, includes a second bright colored ink, and is darker in color than the first coating layer. The shielding layer is formed on the first coating layer and the second coating layer, and completely covers the non-display area. The present disclosure further provides a method for manufacturing the glass sheet.

### FIELD

The subject matter herein generally relates to a glass sheet and a method for manufacturing the glass sheet.

### BACKGROUND

A glass sheet is usually used as a cover to protect a display panel of an electronic device.

### BRIEF DESCRIPTION OF THE DRAWINGS

Implementations of the present technology will now be described, by way of example only, with reference to the attached figures.

FIG. 1 is a top plan view of an embodiment of a glass sheet.

FIG. 2 is a cross-sectional view of the glass sheet of FIG. 1, taken along line II-II of FIG. 1.

FIG. 3 is a flowchart for manufacturing the glass sheet of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

A definition that apply throughout this disclosure will now be presented.

The term “comprising,” when utilized, means “including, but not necessarily limited to”; it specifically indicates open-ended inclusion or membership in the so-described combination, group, series and the like.

A glass sheet can include a base plate, a first coating layer, a second coating layer, and a shielding layer. The base plate can include a display area, and a non-display area surrounding the display area. The first coating layer can be formed on the non-display area of the base plate, can include a first bright colored ink, and can define a number of wiredrawing finishing textures separated from each other. The second coating layer can be filled in the number of wiredrawing finishing textures, can include a second bright colored ink, and be darker in color than the first coating layer. The shielding layer can be formed on the first coating layer and the second coating layer, and can completely cover the non-display area.

A method can be employed for manufacturing a glass sheet. The glass sheet can include a base plate having a display area and a non-display area surrounding the display area, a first coating layer, a second coating layer, and a shielding layer. The method can include: forming the first coating layer on the non-display area to cover the non-display area, solidifying the first coating layer, defining a plurality of wiredrawing finishing textures in the first coating layer, filling the second coating layer in the plurality of wiredrawing finishing textures, solidifying the second coating layer, and forming the shielding layer on the first coating layer and the second coating layer to cover the non-display area.

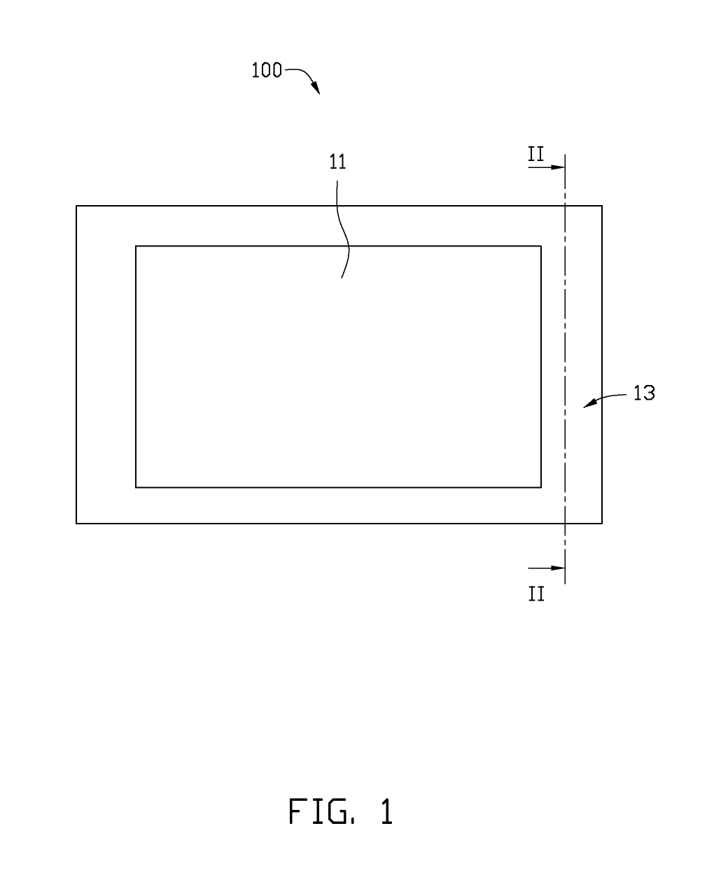

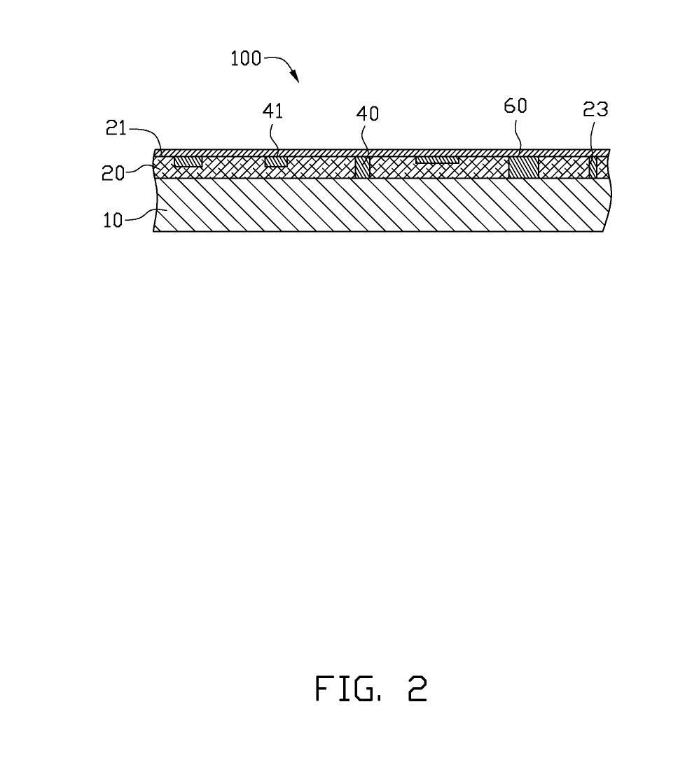

FIGS. 1 and 2 illustrate an embodiment of a glass sheet 100. The glass sheet 100 can be used as a cover glass of an electronic device (not shown). The glass sheet 100 can include a base plate 10, a first coating layer 20, a second coating layer 40, and a shielding layer 60.

The base plate 10 can include a display area 11, and a non-display area 13 surrounding the display area 11. The base plate 10 can be made of glass. The first coating layer 20 can be formed on the display area 11, and can include a top surface 21 away from the base plate 10. The first coating layer 20 can define a number of wiredrawing finishing textures 23 in the top surface 21. The wiredrawing finishing textures 23 can be separated from each other. In at least one embodiment, the wiredrawing finishing textures 23 can be substantially slits defined in the top surface 21, and the slits can have different lengths, widths, and depths from each other. The second coating layer 40 can be filled in the wiredrawing finishing textures 23, and can include a top surface 41 away from the base plate 10. The shielding layer 60 can be formed on the first coating layer 20 and the second coating layer 40, and can completely cover the non-display area 13 of the base plate 10.

The first coating layer 20 and the second coating layer 40 can both be made of bright colored ink, and the second coating layer 40 can be darker in color than the first coating layer 20. In at least one embodiment, the first coating layer 20 can be made of a first bright colored ink with mica powders, and the second coating layer 40 can be made of a second bright colored ink with gold particles or silver particles. The top surface 41 of the second coating layer 40 can be coplanar with the top surface 21 of the first coating layer 20. The shielding layer 60 can be made of opaque ink. In at least one embodiment, the depths, widths, and lengths of the wiredrawing finishing textures 23 can be the same as each other. In at least one embodiment, the top surface 41 of the second coating layer 40 is not coplanar with the top surface 21 of the first coating layer 20.

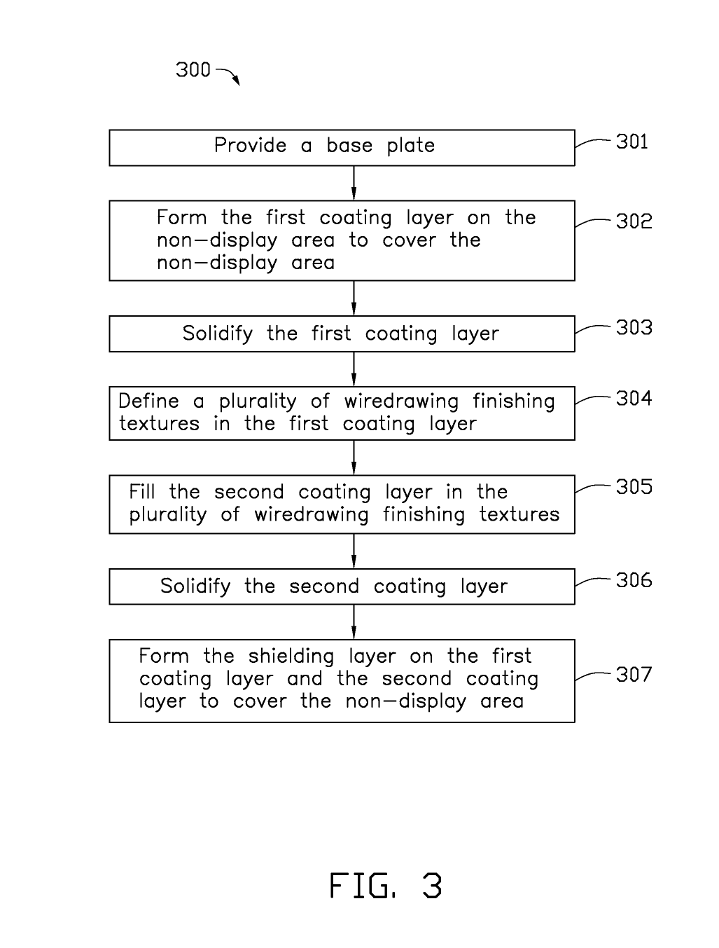

FIG. 3 illustrates a flowchart in accordance with an example embodiment. The method 300 is provided by way of example, as there are a variety of ways to carry out the method. The method 300 described below can be carried out using the configurations illustrated in FIGS. 1 and 2, for example, and various elements of these figures are referenced in explaining example method 300. Each block shown in FIG. 3 represents one or more processes, methods or subroutines, carried out in the example method 300. Furthermore, the illustrated order of blocks is by example only and the order of the blocks can change according to the present disclosure. Additional blocks may be added or fewer blocks may be utilized, without departing from this disclosure. The example method 300 for manufacturing the glass sheet 100 can begin at block 301.

At block 301, a base plate is provided. The base plate can be made of glass, and can include a display area and a non-display area surrounding the display area.

At block 302, a first coating layer is formed on, and covers the non-display area. The first coating layer can be printed on the non-display area according to a screen printing method, and be made of the first bright colored ink, such as ink with mica powders. In at least one embodiment, the first coating layer can be formed on the base plate by one or more methods selected from the group consisting of ink jet printing and magnetron sputtering.

At block 303, the first coating layer is solidified. In at least one embodiment, the first coating layer can be solidified by one or more methods selected from the group consisting of room temperature curing, high temperature curing, and ultraviolet curing, provided that the first coating layer can be solidified.

At block 304, a number of wiredrawing finishing textures are defined in the first coating layer. The wiredrawing finishing textures can be defined by a method of wire drawing treatment, and a steel wire wheel can be used in the wire drawing treatment process to protect the base plate from being damaged. The depths, lengths, and widths of the wiredrawing finishing textures can be different from each other. In at least one embodiment, the depths, lengths, and widths of the wiredrawing finishing textures can be the same as each other.

At block 305, a second coating is filled in the wiredrawing finishing textures. In at least one embodiment, the second coating layer can be filled in the wiredrawing finishing textures by one or more methods selected from the group consisting of screen printing, ink jet printing, and magnetron sputtering, and the top surface of the second coating layer can be coplanar with the top surface of the first coating layer. The second coating layer can be made of the second bright colored ink, such as ink with gold particles or silver particles, and be darker in color than the first coating layer.

At block 306, the second coating layer is solidified. In at least one embodiment, the second coating layer can be solidified by one or more methods selected from the group consisting of room temperature curing, high temperature curing, and ultraviolet curing, provided that the second coating layer can be solidified.

At block 307, a shielding layer is formed on the first coating layer and the second coating layer, and completely covers the non-display area. The shielding layer can be formed by methods well known in the art, such as a coating method, a printing method, and a magnetron sputtering method.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure, as defined by the appended claims.

What is claimed is:

1. A glass sheet comprising:
a base plate comprising:
a display area, and
a non-display area surrounding the display area;
a first coating layer formed on the non-display area of the base plate, comprising a first bright colored ink, and defining a plurality of wiredrawing finishing textures separated from each other;
a second coating layer filled in the plurality of wiredrawing finishing textures and comprising a second bright colored ink, darker in color than the first coating layer; and
a shielding layer formed on the first coating layer and the second coating layer and completely covering the non-display area.

2. The glass sheet of claim 1, wherein the first coating layer is made of ink having mica powders, and the second coating layer is made of ink having silver or golden particles.

3. The glass sheet of claim 1, wherein the depths, lengths, and widths of the plurality of wiredrawing finishing textures are different from each other.

4. The glass sheet of claim 1, wherein the first coating layer has a top surface away from the base plate, the second coating layer has a top surface away from the base plate, and the top surface of the second coating layer is coplanar with the top surface of the first coating layer.

5. A method for manufacturing a glass sheet, the glass sheet comprising a base plate having a display area and a non-display area surrounding the display area, a first coating layer, a second coating layer, and a shielding layer, the method comprising:
forming the first coating layer on the non-display area of the glass sheet to cover the non-display area;
solidifying the first coating layer;
defining a plurality of wiredrawing finishing textures in the first coating layer;
filling the second coating layer in the plurality of wiredrawing finishing textures;
solidifying the second coating layer;
forming the shielding layer on the first coating layer and the second coating layer to cover the non-display area.

6. The method of claim 5, wherein the first coating layer is formed by one or more methods selected from the group consisting of screen printing, ink jet printing, and magnetron sputtering.

7. The method of claim 5, wherein the second coating layer is formed by one or more methods selected from the group consisting of screen printing, ink jet printing, and magnetron sputtering.

8. The method of claim 5, wherein the plurality of wiredrawing finishing textures are formed by a wire drawing treatment method with a steel wire wheel.

9. The method of claim 5, wherein the first coating layer is solidified by one or more methods selected form the group consisting of room temperature curing, high temperature curing, and ultraviolet curing.

10. The method of claim 5, wherein the second coating layer is solidified by one or more methods selected form the group consisting of room temperature curing, high temperature curing, and ultraviolet curing.
